(19) United States
(12) Patent Application Publication
(10) Pub. No.: US 2025/0205666 A1
(43) Pub. Date: Jun. 26, 2025

(54) PROCESSES AND APPARATUSES FOR SUPPORTING CONDUITS IN A RADIAL FLOW REACTOR

(71) Applicant: UOP LLC, Des Plaines, IL (US)

(72) Inventors: Ka L. Lok, Buffalo Grove, IL (US); William B. Duncan, Wadesville, IN (US); Joshua Meyer, Chicago, IL (US)

(21) Appl. No.: 18/919,068

(22) Filed: Oct. 17, 2024

Related U.S. Application Data
(60) Provisional application No. 63/612,690, filed on Dec. 20, 2023.

(51) Int. Cl. B01J 8/02

(52) U.S. Cl. CPC B01J 8/02; B01J 2208/00884

(57) ABSTRACT

An apparatus for supporting conduits in a radial flow reactor. A support plate rests on an internal surface of the reactor below a cylindrical wall of the reactor. Lugs are connected to the support plate and a support ring is supported by the lugs. The conduits are supported by the support ring. Stabilizing plates may be utilized. Also a process of installing such a supporting apparatus in a reactor.

### RELATED APPLICATIONS

This application claims priority to U.S. Provisional Patent Application Ser. No. 63/612,690 filed on Dec. 20, 2023, the entire contents of which are hereby incorporated by reference.

### FIELD OF THE INVENTION

This invention relates generally to the internals for a radial flow reactor and more specifically to supporting conduits.

### BACKGROUND OF THE INVENTION

A wide variety of processes use radial flow reactors to provide for contact between a fluid and a solid. The solid usually comprises a catalytic material on which the fluid reacts to form a product, or an adsorbent for selectively removing a component from the fluid. The processes cover a range of processes, including hydrocarbon conversion, gas treatment, and adsorption for separation.

Radial flow reactors are constructed such that the reactor has an annular structure and that there are annular distribution and collection devices. The devices for distribution and collection incorporate some type of screened surface. The screened surface is for holding catalyst or adsorbent beds in place and for aiding in the distribution of pressure over the surface of the reactor, or adsorber, and to facilitate radial flow through the reactor bed. The screen can be a mesh, either wire or other material, or a punched plate. For a moving bed, the screen or mesh provides a barrier to prevent the loss of solid catalyst particles while allowing fluid to flow through the bed. The screen requires that the holes for allowing fluid through are sufficiently small to prevent the solid from flowing across the screen. Solid catalyst particles are added at the top, and flow through the apparatus and removed at the bottom, while passing through a screened-in enclosure that permits the flow of fluid over the catalyst. The screen is preferably constructed of a non-reactive material, but in reality, the screen often undergoes some reaction through corrosion, and over time problems arise from the corroded screen or mesh.

The screens or meshes used to hold the catalyst particles within a bed are sized to have apertures sufficiently small that the particles cannot pass through. The outer screen element can be provided by a cylindrical screen that retains particles in its interior and provides for the distribution of fluid through the space between the screen and the outer wall of the reactor. Another design for an outer screen element is to use a plurality of oblong conduits arrayed around the wall of the reactor. A common shape for the oblong conduits is a scallop shaped cross-section where the flattened side is positioned against the wall of the reactor and the more sharply curved side presents a screened face that allows the catalyst to flow against, while fluid flows within the oblong conduit and passes through the screened face. The flattened side is shaped to substantially conform to the curve of the reactor wall to minimize volume between the conduits and the reactor wall.

Common scallop designs can be found in U.S. Pat. Nos. 5,366,704 and 6,224,838 and U.S. Pat. Pub. No. 2017/0320033.

To support these conduits, a support ring and various lugs may be used. While effective for their intended purposes, the current installation designs and processes however require welding the lugs to the reactor shell or/and reactor head. This may create problems and require additional time during installation. For example, if the metallurgy of the reactor shell is low chrome, degassing of atomic hydrogen and post weld treatment are needed. These may require additional days during the installation. As would be appreciated, prolonging the turnaround leads to loss production, a significant economic loss to refineries. Additionally, with respect to retrofitting newer conduit designs into existing reactors, it may not be possible to weld to the reactor shell

Accordingly, it would be desirable to provide designs and processes which do not require welding support structures for the conduits to the reactor shell.

### SUMMARY OF THE INVENTION

The present inventors have invented a new apparatus for supporting conduits in a radial flow reactor. The new apparatus is not welded or otherwise attached to the reactor shell-instead a support plate merely rests on the reactor shell. This avoids the need for post weld heat treatment and degassing of atomic hydrogen. Additionally, such an apparatus requires minimal field welding inside the reactors avoid potential field fit-up problems to exiting reactor head during installation. The new apparatus is “neutral” in term of process gas hydraulics, gas flow pattern and solid flow pattern inside the reactor compared to traditional scallop support.

Therefore, the present invention may be characterized, in at least one aspect, as providing an apparatus for supporting conduits in a radial flow reactor having: at least one support plate having an upper surface and a lower surface, the lower surface configured to contact the radial flow reactor; a plurality of lugs, each lug connected to an upper surface of a support plate; and, a support ring supported by the plurality of lugs, wherein the support ring is configured to support the conduits and wherein the at least one support plate is located below a cylindrical wall of the radial flow reactor.

The lower surface may not be attached to the radial flow reactor.

The at least one support plate comprises or forms a flat ring. Each lug may be connected to the upper surface of the flat ring.

The at least one support plate may include a plurality of support plates and each support plate may be connected to one or more lugs and wherein the lugs are disposed in a radial pattern toward a reactor center pipe.

The apparatus may also include a plurality of stabilizing plates connected to the support ring. Each stabilizing plate includes a surface configured to contact the cylindrical wall of radial flow reactor. Each stabilizing plate may be integrally formed with a lug. Each stabilizing plate may be welded or bolted to the support ring.

Each lug may be welded or bolted to an upper surface of a support plate. Each lug may be welded or bolted to the support ring.

In another aspect, the present invention may be broadly characterized as providing a method of installing an apparatus for supporting conduits in a radial flow reactor by: connecting a plurality of lugs to an upper surface of at least one support plate; placing a lower surface of the at least one support plate onto an internal surface below a cylindrical wall of the radial flow reactor; placing a support ring onto the plurality of lugs; and, connecting a plurality of conduits to the support ring.

The method may also include connecting the support ring to the plurality of lugs.

The method may include providing a plurality of stabilizing plates, each stabilizing plate having a surface configured to contact the cylindrical wall of radial flow reactor. Each stabilizing plate may be integrally formed with a lug. The method may include connecting each stabilizing plate to the support ring. The stabilizing plates may be connected before the support ring is placed onto the plurality of lugs.

The lower surface may not be attached to the internal surface of the radial flow reactor.

The at least one support plate may be a flat ring. The method may further include welding each lug to the flat ring before placing the lower surface onto the internal surface of the radial flow reactor.

The method may also include removing a previously installed support structure from the radial flow reactor.

Additional aspects, embodiments, and details of the invention, all of which may be combinable in any manner, are set forth in the following detailed description of the invention.

### DETAILED DESCRIPTION OF THE DRAWINGS

One or more exemplary embodiments of the present invention will be described below in conjunction with the following drawing figures, in which:

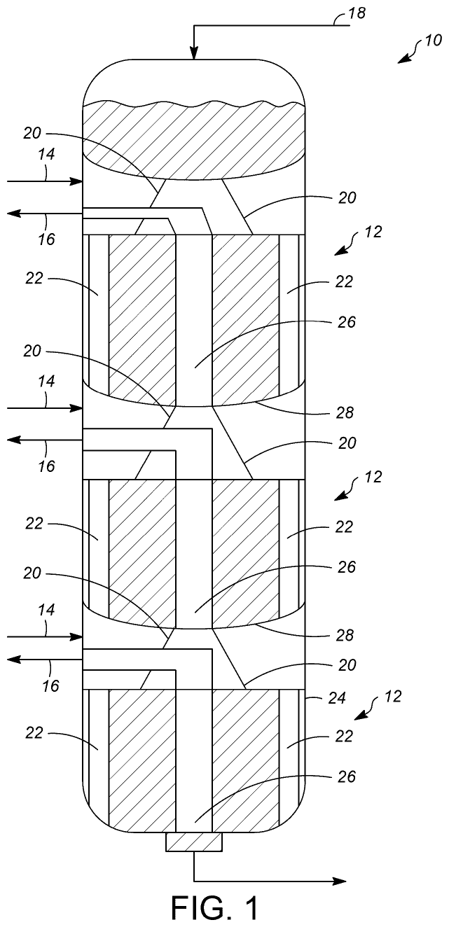

FIG. 1 shows a schematic side cutaway view of a radial flow reactor that may be utilized in accordance with one or more embodiments of the present invention;

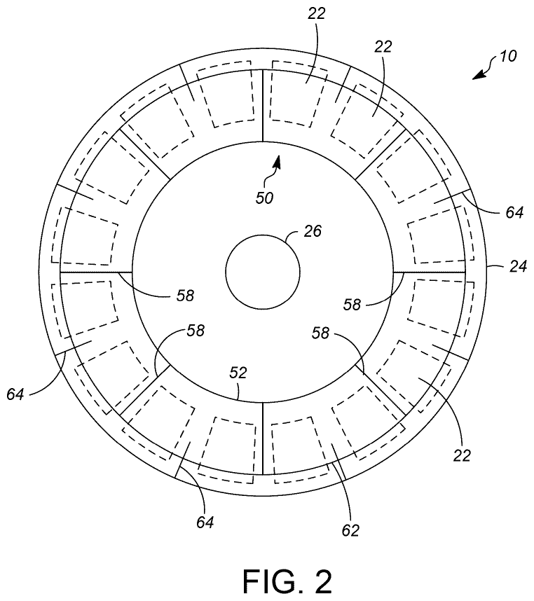

FIG. 2 shows a top schematic view of a radial flow reactor with an apparatus according to one or more aspects of the present invention;

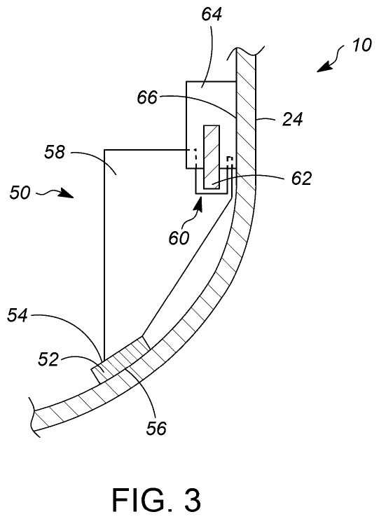

FIG. 3 is a side close up view of a portion of the radial flow reactor shown in FIG. 2;

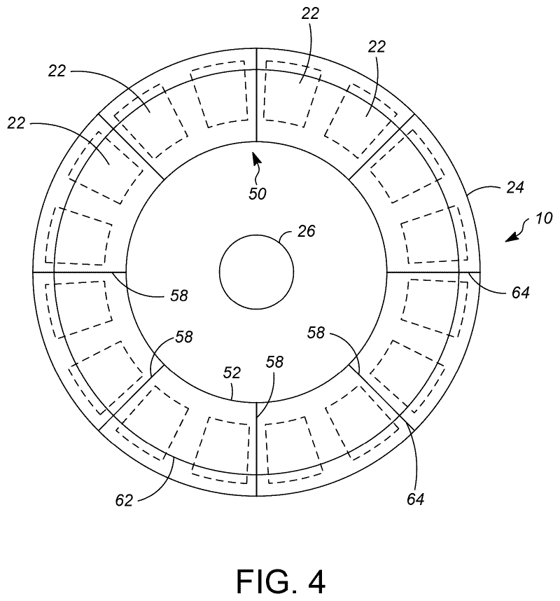

FIG. 4 shows a top schematic view of another radial flow reactor with an apparatus according to one or more aspects of the present invention; and,

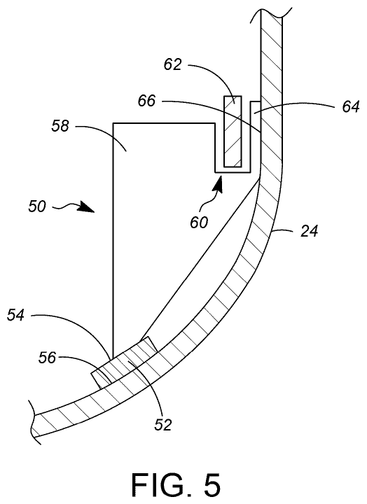

FIG. 5 is a side close up view of a portion of the radial flow reactor shown in FIG. 2.

### DETAILED DESCRIPTION OF THE INVENTION

As mentioned above, a new apparatus for supporting conduits in a radial flow reactor and method of installing same have been invented. The present invention does not require welding to the reactor shell and reactor head. Generally, the apparatus includes two support rings instead of single support ring. Lugs are used to provide for mechanical support.

The lugs and support rings form a “cage” which is significantly stronger system than conventional single ring designs in which support lugs are welded directly to the reactor wall and support a ring. Additionally, the lugs being attached to the lower support ring eliminates the possibility of shearing off the weld of lug to the reactor shell or forming cracks in current design under load and therefore reducing or eliminating the potential for compromising the mechanical integrity of the reactor shell. The lower side section of lug may be tapered so that it can fit in and is compatible any curvature of a given reactor head. This eliminates field modification for fitting-up actual curvature of the existing reactor head. Stabilizer plates may stabilize the cage preventing it from tipping when it is under loaded condition.

With these general principles in mind, one or more embodiments of the present invention will be described with the understanding that the following description is not intended to be limiting.

As shown in FIG. 1, a radial flow reactor 10 has one or more reaction zones 12. Each of the reaction zones 12 receives a feed stream 14 and provides an effluent stream 16. Often, the feed stream 14 for a downstream reaction zone 12 is the effluent stream 16 from an upstream reaction zone 12. The reaction zones 12 also receive a solid, such as a catalyst 18 or sorbent, which may travel between the reaction zones 12 via catalyst transfer pipes 20. Within the reaction zones conduits 22 transport the fluid of the feed stream 14 to the solid. The conduits are located proximate a reactor shell 24. The fluid flows from the conduits, passed the solid, and into a centerpipe 26 which provides the effluent stream 16. The above represents a radial flow reactor for fluid flowing in the direction from conduit 22 to centerpipe 26. Alternatively, a radial flow reactor could have fluid flowing in the direction from centerpipe 26 to conduit 22.

As discussed above, in the present processes the conduits 22 are not welded or otherwise fixedly attached to the reactor shell 24.

Accordingly, as shown in FIGS. 2 to 5, an apparatus 50 for supporting the conduits is shown in more detail. The apparatus 50 includes at least one support plate 52 having an upper surface 54 and a lower surface 56. The support plate(s) 52 is a ring, preferably a flat ring which has a cross sectional shape that is substantially rectangular and which has a contour to the reactor surface it is contacting. If multiple support plates are used, the ring may be formed by connecting a plurality of support plates 52, for example, by welding or bolting the multiple support plates 52 together to form the ring.

The lower surface 56 of the support plate(s) 52 contacts the radial flow reactor 10, at a surface that is below a cylindrical wall portion of the reactor 10. However, unlike conventional designs, the lower surface(s) 56 are not attached to the radial flow reactor 10 but instead merely rest on the reactor shell 24 or on a head 28 of the reactor 10 separating the reaction zones 12 (see FIG. 1).

A plurality of lugs 58 are connected to the upper surface 54 of the support plates 52. Each of the lugs 58 is planar and has a substantial (i.e., +/−10%) radial orientation (i.e., lie in planes passing through the center of the reactor 10). The radial orientation does not interrupt the radial flow pattern of the reactant flowing from the conduit to the centerpipe 26 and it does not interfere of solid transfer from one reaction zone to downstream reaction zone for a moving bed reactor. Similar by placing the lugs 58 in a radial orientation, it does not interrupt solid flow inside the reaction zones 12 for transferring the solid from one reaction zone 12 to the next for a moving solid bed reactor.

Each lug 58 may be welded or bolted or otherwise affixed to the upper surface 54 of the support plate(s) 52. If the flat ring is formed by a plurality of support plates 52, each support plate 52 may be connected to one or more lugs 58.

The lugs 58 include a notch 60 that receives a support ring 62. The support ring 62 supports the conduits 22. The support ring 62 may also have a cross sectional shape that is substantially rectangular. The lugs 58 may be affixed to the support ring 62, for example, by welding or bolting.

The load of the conduits 22 is transferred to the support ring 62. The support ring 62 will transfer the load to lug 58 and the support plate 52. The support plate 52 will transfer the load to the reactor shell 24 or reactor head 28.

Since the support plate(s) 52 are not affixed to the reactor 10, but merely contact the reactor 10, one or more stabilizing plates 64 may be provided. Each stabilizing plate 64 has a surface 66 configured to contact the cylindrical wall of radial flow reactor 10. The stabilizing plates 64 locating at the cylindrical wall of the reactor 10 are provided to reduce and preferably eliminate, the shifting, tilting, or tipping of the apparatus 50. The stabilizing plates 64 may be integrally formed with the lugs 58 or they may be separately provided.

For example, as shown in FIGS. 2 and 3, the stabilizing plates 64 are separate elements that are connected to the support ring 62. The stabilizing plates 64 may be bolted, welded, or otherwise affixed to the support ring 62.

Alternatively, as shown in FIGS. 4 and 5, the stabilizing plates 64 may be formed by a side of the notch 60 of the lug. The side of the notch 60 forming the stabilizing plate 64 has a height greater than an opposite side of the notch 60.

In configurations in which the apparatus 50 is being retrofitted into an existing reactor 10, the installation process may begin with first removing a previously installed support structure from the radial flow reactor 10.

Installation of the apparatus 50 includes connecting the plurality of lugs 58 to the upper surface 54 of the support plate 52. If a plurality of support plates 52 are provided, they may be assembled into the ring before the lugs 58 are connected.

The lower surface 56 of the support plate(s) 52 may be placed onto an internal surface below the cylindrical wall of the radial flow reactor 10. The lower surface 56 is not attached to the internal surface of the radial flow reactor 10.

The support ring 62 may be placed onto the lugs 58 and may or may not be connected or affixed thereto.

The conduits 22 may then be connected to the support ring 62.

If stabilizing plates 64 are provided, the stabilizing plates 64 may be connected to the support ring 62, and that may occur before the support ring 62 is placed onto the plurality of lugs 58.

### SPECIFIC EMBODIMENTS

While the following is described in conjunction with specific embodiments, it will be understood that this description is intended to illustrate and not limit the scope of the preceding description and the appended claims.

A first embodiment of the invention is an apparatus for supporting conduits in a radial flow reactor, the apparatus comprising at least one support plate having an upper surface and a lower surface, the lower surface configured to contact the radial flow reactor; a plurality of lugs, each lug connected to an upper surface of a support plate; and, a support ring supported by the plurality of lugs, wherein the support ring is configured to support the conduits and wherein the at least one support plate is located below a cylindrical wall of the radial flow reactor. An embodiment of the invention is one, any or all of prior embodiments in this paragraph up through the first embodiment in this paragraph, wherein the lower surface is not attached to the radial flow reactor. An embodiment of the invention is one, any or all of prior embodiments in this paragraph up through the first embodiment in this paragraph, wherein the at least one support plate comprises a flat ring. An embodiment of the invention is one, any or all of prior embodiments in this paragraph up through the first embodiment in this paragraph, wherein each lug is connected to the upper surface of the flat ring. An embodiment of the invention is one, any or all of prior embodiments in this paragraph up through the first embodiment in this paragraph, wherein the at least one support plate comprises a plurality of support plates, each support plate connected to one or more lugs and wherein the lugs are disposed in a radial pattern toward a reactor center pipe. An embodiment of the invention is one, any or all of prior embodiments in this paragraph up through the first embodiment in this paragraph, further comprising a plurality of stabilizing plates connected to the support ring, each stabilizing plate having a surface configured to contact the cylindrical wall of radial flow reactor. An embodiment of the invention is one, any or all of prior embodiments in this paragraph up through the first embodiment in this paragraph, wherein each stabilizing plate is integrally formed with a lug. An embodiment of the invention is one, any or all of prior embodiments in this paragraph up through the first embodiment in this paragraph, wherein each stabilizing plate is welded or bolted to the support ring. An embodiment of the invention is one, any or all of prior embodiments in this paragraph up through the first embodiment in this paragraph, wherein each lug is welded or bolted to an upper surface of a support plate. An embodiment of the invention is one, any or all of prior embodiments in this paragraph up through the first embodiment in this paragraph, wherein each lug is welded or bolted to the support ring.

A second embodiment of the invention is a method of installing an apparatus for supporting conduits in a radial flow reactor, the method comprising connecting a plurality of lugs to an upper surface of at least one support plate; placing a lower surface of the at least one support plate onto an internal surface below a cylindrical wall of the radial flow reactor; placing a support ring onto the plurality of lugs; and, connecting a plurality of conduits to the support ring. An embodiment of the invention is one, any or all of prior embodiments in this paragraph up through the second embodiment in this paragraph, further comprising connecting the support ring to the plurality of lugs. An embodiment of the invention is one, any or all of prior embodiments in this paragraph up through the second embodiment in this paragraph, further comprising providing a plurality of stabilizing plates, each stabilizing plate having a surface configured to contact the cylindrical wall of radial flow reactor. An embodiment of the invention is one, any or all of prior embodiments in this paragraph up through the second embodiment in this paragraph, wherein each stabilizing plate is integrally formed with a lug. An embodiment of the invention is one, any or all of prior embodiments in this paragraph up through the second embodiment in this paragraph, further comprising connecting each stabilizing plate to the support ring. An embodiment of the invention is one, any or all of prior embodiments in this paragraph up through the second embodiment in this paragraph, wherein the stabilizing plates are connected before the support ring is placed onto the plurality of lugs. An embodiment of the invention is one, any or all of prior embodiments in this paragraph up through the second embodiment in this paragraph, wherein the lower surface is not attached to the internal surface of the radial flow reactor. An embodiment of the invention is one, any or all of prior embodiments in this paragraph up through the second embodiment in this paragraph, wherein the at least one support plate comprises a flat ring. An embodiment of the invention is one, any or all of prior embodiments in this paragraph up through the second embodiment in this paragraph, further comprising welding each lug to the flat ring before placing the lower surface onto the internal surface of the radial flow reactor. An embodiment of the invention is one, any or all of prior embodiments in this paragraph up through the second embodiment in this paragraph, further comprising removing a previously installed support structure from the radial flow reactor.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

What is claimed is:

1. An apparatus for supporting conduits in a radial flow reactor, the apparatus comprising:
at least one support plate having an upper surface and a lower surface, the lower surface configured to contact the radial flow reactor;
a plurality of lugs, each lug connected to an upper surface of a support plate; and,
a support ring supported by the plurality of lugs, wherein the support ring is configured to support the conduits, and
wherein the at least one support plate is located below a cylindrical wall of the radial flow reactor.

2. The apparatus of claim 1, wherein the lower surface is not attached to the radial flow reactor.

3. The apparatus of claim 1, wherein the at least one support plate comprises a flat ring.

4. The apparatus of claim 3, wherein each lug is connected to the upper surface of the flat ring.

5. The apparatus of claim 1, wherein the at least one support plate comprises a plurality of support plates, each support plate connected to one or more lugs, and
wherein the one or more lugs are disposed in a radial pattern toward a reactor center pipe.

6. The apparatus of claim 1, further comprising:
a plurality of stabilizing plates connected to the support ring, each stabilizing plate having a surface configured to contact the cylindrical wall of radial flow reactor.

7. The apparatus of claim 6, wherein each stabilizing plate is integrally formed with a lug.

8. The apparatus of claim 6, wherein each stabilizing plate is welded or bolted to the support ring.

9. The apparatus of claim 1, wherein each lug is welded or bolted to an upper surface of a support plate.

10. The apparatus of claim 9, wherein each lug is welded or bolted to the support ring.

11. A method of installing an apparatus for supporting conduits in a radial flow reactor, the method comprising:
connecting a plurality of lugs to an upper surface of at least one support plate;
placing a lower surface of the at least one support plate onto an internal surface below a cylindrical wall of the radial flow reactor;
placing a support ring onto the plurality of lugs; and,
connecting a plurality of conduits to the support ring.

12. The method of claim 11, further comprising:
connecting the support ring to the plurality of lugs.

13. The method of claim 11, further comprising:
providing a plurality of stabilizing plates, each stabilizing plate having a surface configured to contact the cylindrical wall of radial flow reactor.

14. The method of claim 13, wherein each stabilizing plate is integrally formed with a lug.

15. The method of claim 13, further comprising:
connecting each stabilizing plate to the support ring.

16. The method of claim 15, wherein the stabilizing plates are connected before the support ring is placed onto the plurality of lugs.

17. The method of claim 11, wherein the lower surface is not attached to the internal surface of the radial flow reactor.

18. The method of claim 11, wherein the at least one support plate comprises a flat ring.

19. The method of claim 18, further comprising:
welding each lug to the flat ring before placing the lower surface onto the internal surface of the radial flow reactor.

20. The method of claim 11, further comprising:
removing a previously installed support structure from the radial flow reactor.
